(19) United States
(12) Patent Application Publication
(10) Pub. No.: US 2020/0055258 A1
(43) Pub. Date: Feb. 20, 2020

(54) HIGH STRENGTH POLYMER METAL COMPOSITES AND METHODS OF MAKING THEREOF

(71) Applicant: IPG PHOTONICS CORPORATION, Oxford, MA (US)

(72) Inventors: Anthony HOULT, Campbell, CA (US); Katrin WOLF, Stuttgart (DE)

(21) Appl. No.: 16/610,247

(22) PCT Filed: May 2, 2018
(86) PCT No.: PCT/US2018/030573

§ 371 Date: Nov. 1, 2019

Related U.S. Application Data
(60) Provisional application No. 62/500,140, filed on May 2, 2017.

(51) Int. Cl. B29C 65/16; B29C 65/82; B29C 65/00

(52) U.S. Cl. CPC B29C 65/16; B29C 65/8253; B29C 66/7422; B29C 66/74283; B29C 66/73161; B29C 66/939; B29C 66/919; B29C 2791/009; B29C 2791/001; B29C 66/71

(57) ABSTRACT

The present invention provides polymer-metal composites free of adhesives and methods of making same. In particular, the present invention takes advantage of a unique metallic bonding surface created by exposure to a laser whereby micron-sized fragments are fixed to the metallic bonding surface such that a high strength bond with polymeric material is created upon exposure to a second laser.

### BACKGROUND OF THE INVENTION

### Field of the Disclosure

The disclosure relates to polymer to metal composites characterized by bonds free of adhesives that provide a high strength joint as well as the methods of making such composites.

### Background

The use of lasers to join dissimilar materials is well known. For example, Gisario et al. disclosed the direct, dissimilar joining of transparent PET and PET-PEVA composites to aluminum 7075 sheets using diode lasers. See Abstract #2106, ICALEO Meeting, Oct. 16- 20, 2016. That paper further discussed a variety of previous attempts to use lasers to bond different metals and polymers, as well as direct bonding of carbon fibers to polymers, to each other.

The problem with the paper and the other prior art disclosures is that they seek to determine the optimum polymeric composition to join with the aluminum rather than the optimum surface characteristics of the materials themselves.

Indeed, applications in industry dictate the use of specific combinations of materials that are tried and tested, if not required by industry regulations. Examples include the limited number of polymers and metals acceptable for use in the medical device field.

Other material combinations are required for their esthetic appeal, such that manipulation of either the metal composition and/or the polymeric composition is not commercially feasible. For example, metals and polymers that provide attractive cosmetic attributes that automobile manufacturers desire are limited due to both their commercial appeal as well as their cost.

The creation of roughened surfaces with respect to the bonding of polymerics to metallic substrates has also recently been disclosed. See Yasuda, K. et al. Materials Science and Engineering 61 (2014). The process disclosed therein requires numerous chemical treatments of the metallic substrate with acid to create a sufficient surface roughness. Moreover, the morphology of the roughened surface subsisted of mounds on top of mounds, not an optimum surface for mechanical bonding, as no interstices between the substrate surface and the raised surfaces are created.

The need for polymeric/metallic composites that are commercially desirable but also have their maximum strength, while free of adhesive and having a low cost have heretofore not been achieved. The present invention solves all these problems in the prior art.

### SUMMARY OF THE INVENTION

The present invention provides polymeric-metallic composites (“PMC”) free of adhesive and characterized by their bond strength in that the composites fail cohesively, in the bulk substrate, rather than at the bond locations, that is adhesively. The PMC of the present invention includes a metallic substrate characterized by a bulk portion and a bonding surface, the surface including a plurality of fragments fixed thereto with interstices there between; the fragments characterized by having (i) a maximum measureable dimension less than 50 microns, and (ii) having the same composition as the bulk portion. The polymeric portion of the PMC is characterized by a polymeric substrate characterized by a portion thereof inhabiting at least a portion of the interstices in the metallic substrate bonding surface described above, wherein the composite is further characterized by the absence of any adhesive and its cohesive rather than adhesive failure when subjected to standard strength tests.

The inventors discovered that the in order to create metallic substrates suitable for bonding, the characteristics of different metals would not all be the same. Experimentation led to the separation of the metallic substrates into two groups, group one that included steel, titanium and nitinol and group two that included aluminum, aluminum oxide and other aluminum alloys.

In a preferred embodiment, the metallic bonding surface of the PMC is characterized by fragments that are arranged in a plurality of ranks. In another preferred embodiment of the present invention, the metallic bonding surface of the PMC, prior to its bonding to the polymeric substrate, is characterized by a contact angle less than 10.

The present invention is successful as a result of the fragments described above providing enough surface area to maximize the mechanical bond between the layers. One measure thereof is the surface roughness of the metallic bonding surface prior to bonding with the polymeric substrate. In preferred embodiment the surface roughness for a group one metal substrate is characterized by an. Rz value between 4 and 8.5 microns and a Ra value between 0.5 and 1.6 microns. In preferred embodiment the surface roughness for a group two metal substrate is characterized by an Rz value around 38 microns and a Ra value between about 6.7 and 7 microns.

As more fully set forth below, the method of creating the bonding surface leaves a surface replete with micron-sized fragments fixed thereto. In a preferred embodiment, the present invention provides a PMC with a metallic bonding surface characterized by 75% or more of the fragments having a maximum measurable dimension less than 10 microns. In a further preferred embodiment, the bonding surface is characterized by 90% or more of the fragments having a maximum measureable dimension less than 10 microns.

As set forth above, the premise of the present invention is high strength bonds between the metallic and polymeric layers of a directly bonded PMC. Accordingly, in a preferred embodiment, the bond between the two substrates is characterized by a maximum load greater than 380 N.

The present invention is enabled by and claims a method of creating PMCs. This method is characterized by first exposing a surface of a metallic substrate with a laser energy sufficient to create a treated surface characterized by micron-sized particulate structures fixed thereto, the particulate structures having the same composition as the substrate; positioning a pre-determined polymeric material adjacent the treated surface; and exposing the adjacent polymer and metallic components with a laser energy sufficient to melt the polymeric material such that portions thereof flow between the micron-sized particulate structures on the treated surface such that a high strength mechanical bond is created there between. In a preferred embodiment the laser used to treat the surface of the metal substrate is scanned across the surface. In a further embodiment, the laser is scanned in such a manner such that the textured surface includes fragments arranged in ranks.

### DETAILED DESCRIPTION OF THE INVENTION

The present invention provides improved polymeric-metallic composites and methods for producing same. Set forth below are the data supporting both the compositions and methods used to produce the novel compositions.

The texturing of the metallic substrates investigated provided some subtle differences. In particular, the present inventors discovered that no universal laser energy, nor universal laser, provided the bonding surface sufficient to create the high strength mechanical bonds that were the object of the present invention. Particularly, the present inventors found a distinction between two groups of metallic substrates: the first being a group of stainless steel, titanium and nitinol and the second group being aluminum and anodized aluminum. As the data set forth below provides, the second group required much higher Ra and Rz measurements to provide the strengths needed. In order to provide such higher roughness characteristics, the present inventors experimented with other lasers and found a second laser that was able to produce a more desirable bonding surface.

The optimum texture for the first group of metallic substrates was produced by a YLPP-1-150V-30 laser produced by IPG Photonics of Oxford, Mass. This 1064 λ pulsed laser provided pulses with a 5 ns width at a pulse repetition rate of 100 kHz. The speed was set for 1000 mm/s with a fill of 0.1 mm and was operated in a Boustrophedonic pattern.

While the laser used for the first group could provide serviceable bonding to create metallic-polymeric composites, the optimum texture for the second group of metallic substrates was produced by a second laser, a YLP-V2-1-100-50-50-LM laser produced by IPG Photonics of Oxford, Mass. This 1064 λ pulsed laser provided pulses with a 100 ns width at a pulse repetition rate of 150 kHz. The speed was 1000 mm/s with a fill of 0.0055 mm and was operated in a Boustrophedonic pattern.

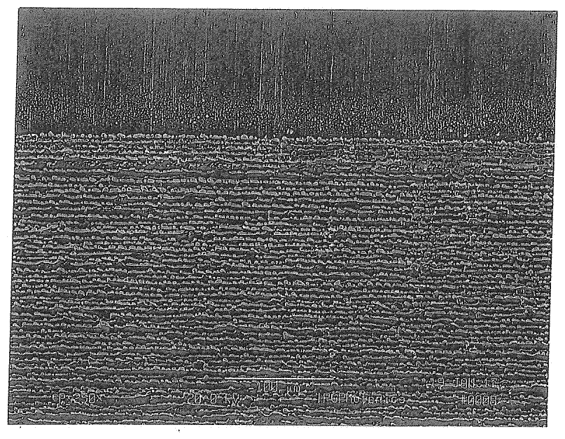

FIG. 1 provides a scanning electron micrograph of 304 stainless steel sample surface after texturing but before bonding. Note the fragments on the surface being arranged in ranks due to the Boustrophedonic pattern in which the laser was operate. Further note the small, fairly uniform particle size of the fragments, all of which are substantially smaller than 25 microns in diameter.

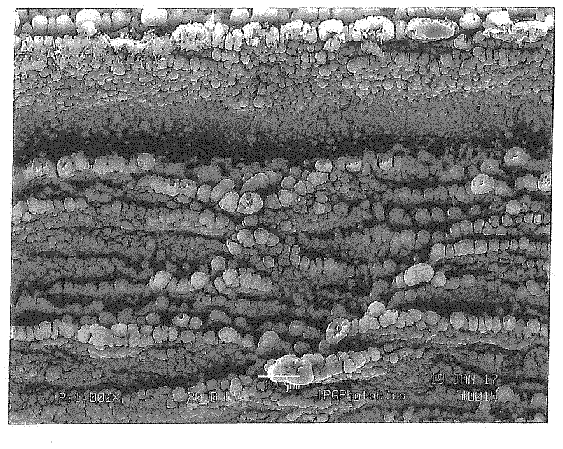

FIG. 2 provides a scanning electron micrograph of titanium sample surface after texturing but before bonding. This SEM is at a higher magnification than FIG. 1 and sets forth fragments, substantially all of which have a maximum measurable diameter of less than 10 microns. Per FIG. 1, the fragments are arranged in ranks.

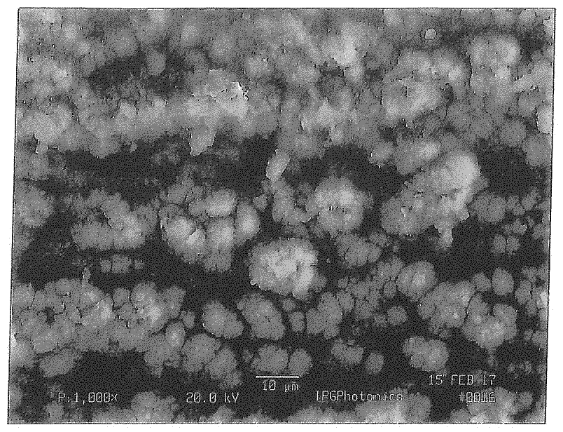

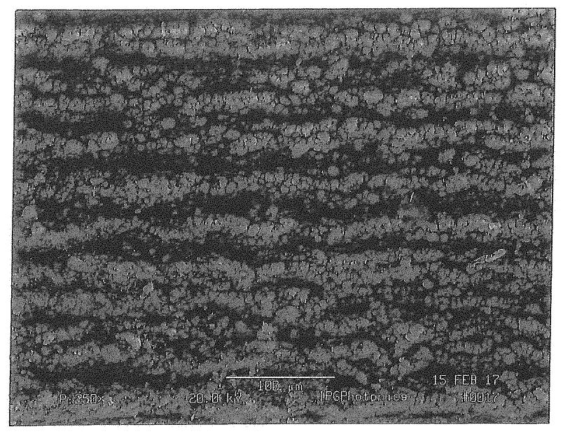

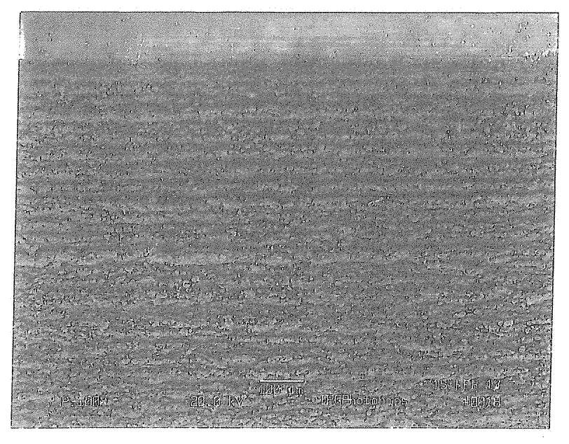

FIGS. 3-5 are SEMS of aluminum sample surfaces after texturing but before bonding. While the general appearance of the particles in terms of size and orientation are similar to those of FIGS. 1 and 2, upon close inspection of FIG. 3, the fragments themselves are not solid but have further crevices therein, such that they provide even more surface area than that provided by the metal substrates of the first group. Note further that the ranks are not as prominently separated, as they are not truly distinguishable until the magnification is set at 100 microns FIGS. 4-5).

The parameters used for the bonding of polymeric materials to group one metallic substrates (stainless steel, titanium and nitinol) are set forth herein below. A TLM-120-WC laser, provided by IPG Photonics of Oxford, Mass., was used for this portion of the invention. The λ 1940.2 nm laser was operated at a speed of 100 mm/s at 61% power level, with the beam scanned over the sample, with a 0.75 mm distance between each lines, with multiple passes (2 or 3) were made, for the boding of high density polyethylene (HDPE) to the group one metallic substrates. With respect to the bonding of the group one substrates to thick poly carbonate (PC), the processing parameters were altered somewhat. Specifically, the line width between passes was narrowed to 0.5 mm, the power was reduced to 33% and the number of passes was increased (5-9 passes).

With respect to thin PC to the metallic substrates of group one, the laser was operated at 23% with a distance of 0.5 mm between each pass. For this material, a complete single pass was made, with repetitions for as many as 4 times to complete bonding.

The parameters used for the bonding of HDPE to group two metallic substrates (aluminum and anodized aluminum) are set forth herein below. A TLM-120-WC laser, provided by IPG Photonics of Oxford, Mass., was used for this portion of the invention. The λ 1940.2 nm laser was operated at a speed of 100 mm/s. The distance between lines was 0.75 mm and the power was varied between 50 and 66%. 1-6 passes were made on each line.

The parameters used for the bonding of PC to group two metallic substrates (aluminum and anodized aluminum) are set forth herein below. A TLM-120-WC laser, provided by IPG Photonics of Oxford, Mass., was used for this portion of the invention. The λ 1940.2 nm laser was operated at a speed of 280 mm/s. Where the distance between lines was 0.50 mm and the power was 33%, 45 passes were made on each line. Where the distance between lines was 0.75 mm and the power was 33%, 30 passes per line were made.

Table 1 set forth below provides the data associated with the above experiments. It sets for the metallic substrate and accompanying polymer, as well as the strength of the maximum load. It accentuates that the materials were tested to a cohesive failure, rather than a failure of the bond.

TABLE 1

| | | Thickness | | Thickness | | max. | |
|---|---|---|---|---|---|---|---|
| Sample | | Metal | | Polymer | max. | Load | Laser |
| # | Metal | (mm) | Polymer | (mm) | Load | Polymer | Used |
| 1 | SS 304 | 0.25 | HD-Polyethylene | 1.6 | 1250N | 1290N | YLPP |
| 2 | SS 304 | 0.25 | thick Polycarbonate | 2.85 | 1345N | 4810N | YLPP |
| 3 | SS 304 | 0.25 | thin Polycarbonate | 0.25 | 400N | 400N | YLPP |
| 4 | SS 304 | 0.25 | ABS 40 | 0.7 | 830N | 890N | YLPP |
| 5 | SS 304 | 0.25 | Copolyester TRITAN | 3.4 | 960N | | YLPP |
| | | | Mx711 | | | | |
| 6 | SS 304 | 0.25 | Copolyester Tx 2000 | 0.25 | 570N | 630N | YLPP |
| 7 | SS 304 | 0.25 | PVC | 0.5 | 690N | | YLPP |
| 8 | SS 304 | 0.25 | PMMA | 1.25 | 780N | | YLPP |
| 9 | AL66-20 | 0.5 | HD Polyethylene | 1.6 | 850N | 1290N | YLP |
| 10 | AL66-20 | 0.5 | thick Polycarbonate | 2.85 | — | 4810N | YLPP |
| 11 | AL66-20 | 0.5 | thin Polycarbonate | 0.25 | — | 400N | YLPP |
| 12 | ano Al | 0.4 | HD Polyethylene | 1.6 | 1065N | 1290N | YLP |
| 13 | ano Al | 0.4 | thick Polycarbonate | 2.85 | 1375N | 4810N | YLPP |
| 14 | ano Al | 0.4 | thin Polycarbonate | 0.25 | — | 400N | YLPP |
| 15 | ano Al | 0.4 | Copolyester TRITAN | 3.4 | 980N | | YLPP |
| | | | Mx711 | | | | |
| 16 | Titanium | 0.2 | HD Polyethylene | 1.6 | 1090N | 1290N | YLPP |
| 17 | Titanium | 0.2 | thick Polycarbonate | 2.85 | 1550N | 4810N | YLPP |
| 18 | Titanium | 0.2 | thin Polycarbonate | 0.25 | 380N | 400N | YLPP |
| 19 | Nitinol | 0.25 | HD Polyethylene | 1.6 | 1050N | 1290N | YLPP |
| 20 | Nitinol | 0.25 | thick Polycarbonate | 2.85 | — | 4810N | YLPP |
| 21 | Nitinol | 0.25 | thin Polycarbonate | 0.25 | — | 400N | YLPP |

Those skilled in the art will recognize or be able to ascertain using no more than routine experimentation many equivalents to the specific embodiments of the invention described herein. The disclosed experiments and the impetus for the presently disclosed compositions and methods lie in the use of the materials, lasers and testing methodology available to the inventors. It is therefore to be understood that the foregoing embodiments are presented by way of example only and that within the scope of the appended claims and equivalents thereto, the invention may be practiced otherwise than as specifically described. The present disclosure is directed to each individual feature, system, material and/or method described herein. In addition, any combination of two or more such features, systems, materials and/or methods, if such features, systems, materials and/or methods are not mutually inconsistent, is included within the scope of the present invention.

1. A polymeric-metallic composite material, the composite comprising
a metallic substrate characterized by a bulk portion and a bonding surface, the surface including a plurality of fragments fixed thereto with interstices there between; the fragments characterized by having (i) a maximum measureable dimension less than 50 microns, and (ii) substantially the same composition as the bulk portion; and
a polymeric substrate characterized by a portion thereof inhabiting at least a portion of the interstices, wherein the composite is further characterized by the absence of any adhesive and its cohesive rather than adhesive failure when subjected to standard strength tests.

2. The polymeric-metallic composite material of claim 1, wherein the fragments are arranged in a plurality of ranks.

3. The polymeric-metallic composite material of claim 1, wherein the bonding surface prior to its combination with the polymeric substrate is characterized by a contact angle less than 10.

4. The polymeric-metallic composite material of claim 1, wherein the metallic substrate is selected from the group of metals including steel, titanium and nitinol.

5. The polymeric-metallic composite material of claim 1, wherein the metallic substrate is selected from the group of metals including aluminum, aluminum oxide and other aluminum alloys.

6. The polymeric-metallic composite material of claim 4, wherein the bonding surface prior to its combination with the polymeric substrate is characterized by an Rz range from 4 and 8.5 microns.

7. The polymeric-metallic composite material of claim 4, wherein the bonding surface prior to its combination with the polymeric substrate is characterized by an Ra range from 0.5 and 1.6 microns.

8. The polymeric-metallic composite material of claim 5, wherein the bonding surface prior to its combination with the polymeric substrate is characterized by an Rz value around 38 microns.

9. The polymeric-metallic composite material of claim 5, wherein the bonding surface prior to its combination with the polymeric substrate is characterized by an Ra range from 6.7 to 7 microns.

10. The polymeric-metallic composite material of claim 1, wherein the bonding surface is characterized by 75% or more of the fragments having a maximum measurable dimension less than 10 microns.

11. The polymeric-metallic composite material of claim 1, wherein the bonding surface is characterized by 90% or more of the fragments haying a maximum measureable dimension less than 10 microns.

12. The polymeric-metallic composite material of claim 1, wherein the bond between the two substrates is characterized by a maximum load greater than 380 N.

13. A method of creating polymeric-metallic composites, the method comprising;
exposing a surface of a metallic substrate with a laser energy sufficient to create a treated surface characterized by micron-sized particulate structures thereon, the particulate structures having the same composition as the substrate and fixed thereto;
positioning a pre-determined polymeric material adjacent the treated surface;
exposing the adjacent polymer metallic components with a laser energy sufficient to melt the polymeric material such that portions thereof flow between the micron-sized particulate structures on the treated surface such that a high strength mechanical bond is created there between.

14. The method of claim 13, wherein the metallic substrate is exposed to a pulse laser.

15. The method of claim 14, wherein the pulsed laser has pulse widths greater between 5 ns and 200 ns.

16. The method of claim 14, wherein the metallic substrate is exposed to pulse widths in a range from 150 ps to 5 ns.

17. The method of claim 13, wherein the metallic substrate is exposed by the laser in a boustrophedonic pattern.

18. The method of claim 13, wherein the laser used to melt the polymeric materials is a thulium fiber laser.
